(19) United States
(12) Patent Application Publication
(10) Pub. No.: US 2010/0116966 A1
(43) Pub. Date: May 13, 2010

(54) Machine tool platform

(76) Inventor: Chien-Cheng Lin, Taichung (TW)

Correspondence Address: Dr. BANGER SHIA;Patent Office of Bang Shia, 102 Lindencrest Ct., Sugar Land, TX, 77479-5201, US

(21) Appl. No.: 12/269,847

(22) Filed: Nov. 12, 2008

(51) Int. Cl. F16M 13/00; F16M 11/00

(52) U.S. Cl. 248/638; 248/562; 248/678

(57) ABSTRACT

A machine tool platform producing a lateral restraining force comprises a lower base and an upper support that are connected to each other through plural mattresses. The lower base is provided with plural elastic elements, the upper support is provided with plural stopping members. By such arrangements, if the upper support horizontally vibrates relative to the lower base, the elastic elements and the stopping members can be used to produce a lateral restraining force to suppress the vibration.

### BACKGROUND OF THE INVENTION

1. Field of the Invention

The present invention relates to an accessory for a machining tool, and more particularly to a machine tool platform producing a lateral restraining force.

2. Description of the Prior Art

Conventionally, machine tools are mostly directly fixed on the ground, and they will cause vibration during machining process, since the ground cannot absorb the vibration of machine tools, the vibration will completely act on the machine tools, thus not only shortening the service life of the parts of the machine tools, but adversely affecting the quality of products.

Hence, a conventional machine tool platform was developed on the market, as shown in FIG. 1. This conventional machine tool platform comprises a lower base A and an upper support B. The lower base A is connected to the upper support B through plural mattresses C. When a machine tool (such as gantry crane) is disposed on the upper support B, the vibration caused by the machine tool can be transmitted to the upper support B. Since the lower base A is connected to the upper support B through the mattresses C, the upper support B can utilize the mattresses C to vibrate relative to the lower base A and alleviate the influence of the vibration of the machine tool on the machining process.

However, if the upper support B is driven by the machine tool to vibrate severely, the mattresses C will be possibly damaged. Therefore, between the lower base A and the upper support B is additionally provided a grease damper used to increase resistance of the vibration of the upper support B or a linkage rod used to connect the upper support B and the lower base A. Both the grease damper and the linkage rod can decrease the vibration range of the upper support B relative to the lower base A to reduce the load on the mattresses.

The grease damper is difficult to exert a fine vibration-suppressing effect when the upper support B vibrates severely. The linkage rod connects the upper support B and the lower base A, so that when the linkage rod is not actuated, it can partially transmit the vibration to the lower base A, thus affecting the vibration suppression effect of the mattresses.

Hence, from the angle of substantially reducing the load on the mattresses C but not reducing the effect of vibration suppression of the mattresses C, the inventor of the present invention has developed a machine tool platform producing a lateral suppressing force.

### SUMMARY OF THE INVENTION

The primary objective of the present invention is to provide a machine tool platform producing a lateral restraining force which is provided with plural elastic elements and plural stopping members that are oppositely located between a lower base and an upper support, so that if the upper support utilizes the mattresses to horizontally vibrate relative to the lower base, the elastic elements will be compressed by the stopping members to produce a counterforce to act as a lateral restraining force to reduce the range of vibration to offer the effect of vibration reduction.

In order to achieve the above objective, the machine tool platform in accordance with the present invention comprises a lower base, an upper support, plural elastic elements and plural stopping members. The lower base is connected to the upper support through plural mattresses in such a manner that the upper support can float above the lower base. The elastic elements are disposed on the lower base, and the stopping members are disposed on the upper support. The respective elastic elements are located opposite the respective stopping members in the horizontal direction.

When a machine tool is disposed on the upper support and actuated to produce vibration, the upper support will be driven to horizontally vibrate relative to the lower base through the mattresses, so that when the respective stopping members are driven to move horizontally, they will be brought into contact to and compress the respective elastic elements, and then the respective elastic elements and stopping members will produce a counterforce, which can act as the lateral restraining force of the upper support to reduce the range of the vibration of the upper support to suppress the vibration.

In addition, when the respective elastic elements are brought into contact to the respective stopping members, the respective elastic elements will be compressed to avoid the occurrence of vibration due to impact. Furthermore, the respective elastic elements and the respective stopping members are separate from each other if no vibration occurs, so that the vibration of the upper support cannot be transmitted to the lower base, thus further improving the effect of vibration reduction.

### BRIEF DESCRIPTION OF THE DRAWINGS

FIG. 1 is a plane view of a conventional machine tool platform;

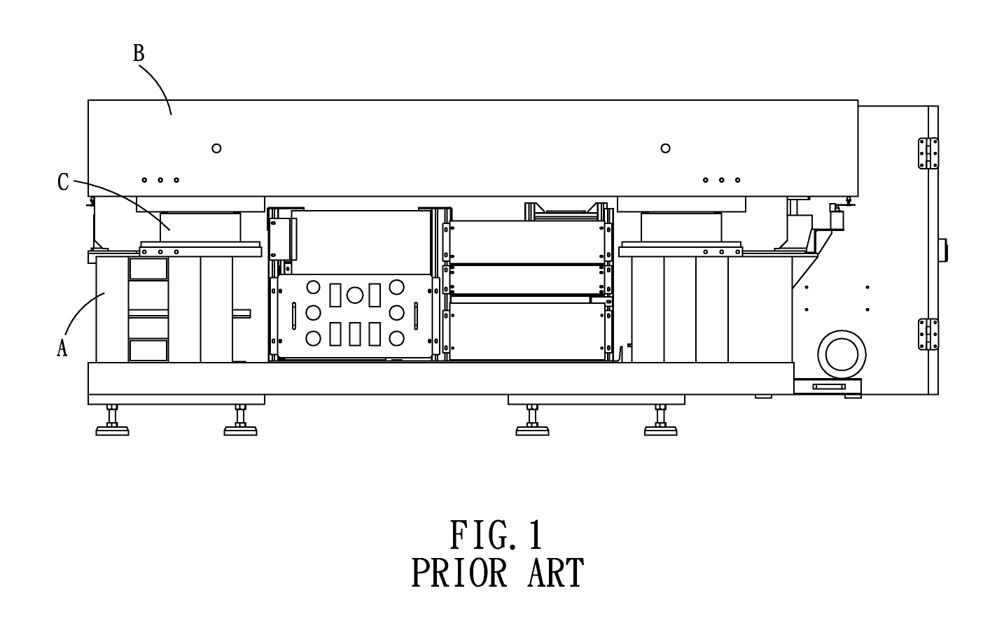

FIG. 2 is a plane view of a machine tool platform in accordance with the present invention; and

FIG. 3 is an enlarged view of the elastic elements and the stopping members in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

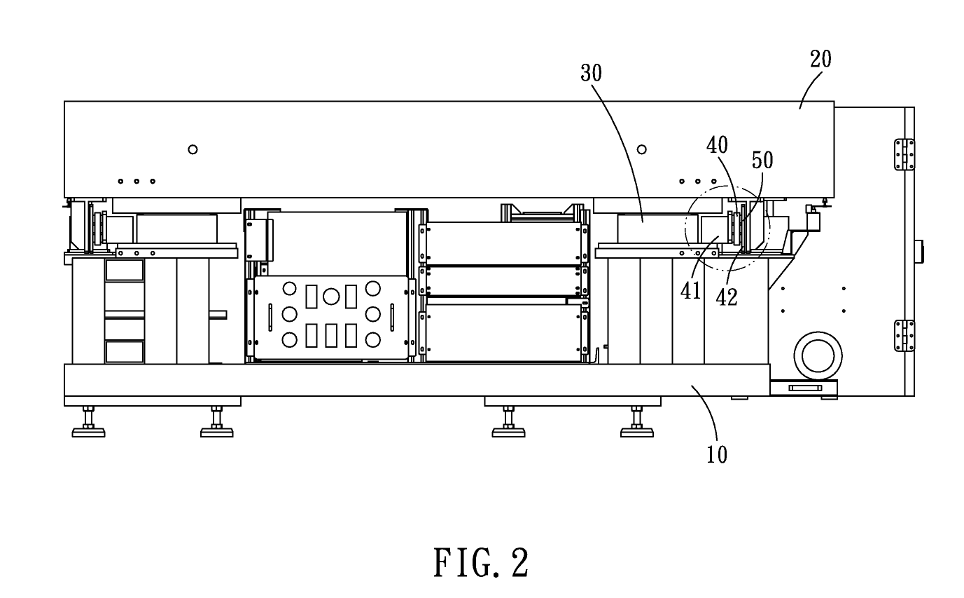

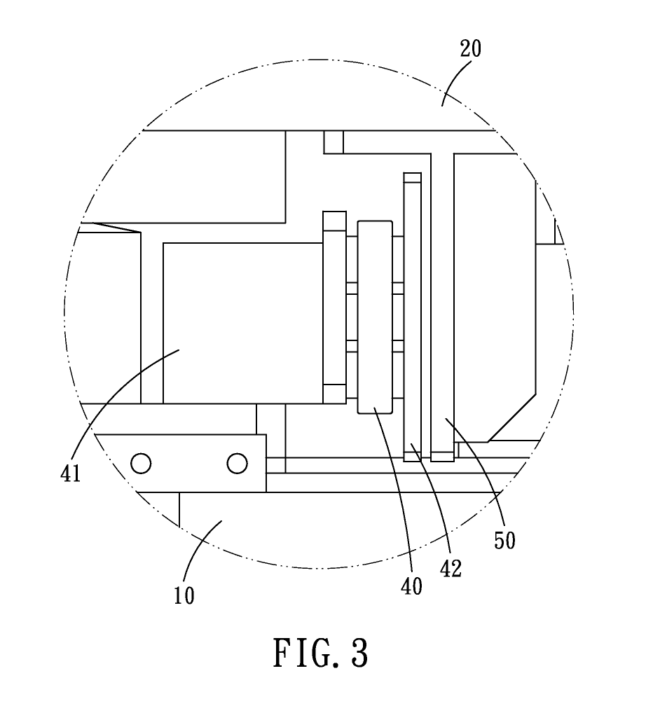

Referring to FIGS. 2-3, a machine tool platform in accordance with the present invention comprises a lower base 10, an upper support 20, plural elastic elements 40 and plural stopping members 50.

The upper support 20 is connected to the lower base 10 through plural mattresses 30 in such a manner that the upper support 20 can float above the lower base 10.

The plural elastic elements 40 are disposed on the lower base by a support frame 41. In the present embodiment, one end of each of the elastic elements 40 is connected to the support frame 41, and the other end of each of the elastic elements 40 is connected to a push plate 42. The elastic elements 40 can be springs, elastic plates or elastomers.

The plural stopping members 50 are disposed on the upper support 20, and located opposite the respective push plates 42 of the elastic elements 40 in the horizontal direction.

When a machine tool is disposed on the upper support 20 and actuated, the vibration caused by the operation of the machine tool will drive the upper support 20 to vibrate synchronously. The upper support 20 will then utilize the mattresses 30 to vibrate horizontally relative to the lower base 10. When the stopping members 50 of the upper support 20 are brought into contact to the push plates 42 of the elastic elements 40 of the lower base 10 during the process of vibration, the elastic elements 40 will absorb the resultant impact force and then be compressed, thus avoiding the occurrence of vibration due to impact.

Furthermore, the impact of the respective push plates 42 and the respective stopping members 50 will produce a counterforce, which will act in a direction opposite to the direction of the vibration of the upper support 20, so that the resultant counterforce can serve as the lateral restraining force of the upper support 20 to reduce the range of vibration of the upper support 20, thus reducing vibration.

In addition, the respective push plates 42 are brought into contact with the respective stopping members 50 only if the upper support 20 vibrates, so that the vibration of the upper support 20 will not be transmitted to the lower base 10 through the elastic elements 40 and the stopping members 50, thus improving the effect of vibration reduction.

While we have shown and described various embodiments in accordance with the present invention, it is clear to those skilled in the art that further embodiments may be made without departing from the scope of the present invention.

What is claimed is:

1. A machine tool platform producing a lateral restraining force comprising: a lower base and an upper support that are connected to each other through plural mattresses in such a manner that the upper support floats above the lower base; the machine tool platform producing a lateral restraining force being characterized in that:
the lower base is provided with plural elastic elements, the upper support is provided with plural stopping members, the respective elastic elements are located opposite the respective stopping members in a horizontal direction, a counterforce produced when the respective elastic elements are brought into contact to the respective stopping members acts as a lateral restraining force.

2. The machine tool platform producing a lateral restraining force as claimed in claim 1, wherein the respective elastic elements are disposed on the lower base by a support frame in such a manner that one end of each of the elastic elements is connected to the support frame, and the other end of each of the elastic elements is connected to a push plate, the push plates are located opposite the respective stopping members in the horizontal direction.

3. The machine tool platform producing a lateral restraining force as claimed in claim 1, wherein the elastic elements are springs.

4. The machine tool platform producing a lateral restraining force as claimed in claim 1, wherein the elastic elements are elastic plates

5. The machine tool platform producing a lateral restraining force as claimed in claim 1, wherein the elastic elements are elastomers.
